(19) United States
(12) Patent Application Publication
(10) Pub. No.: US 2026/0106184 A1
(43) Pub. Date: Apr. 16, 2026

(54) FUEL CELL SEPARATOR AND FUEL CELL SEPARATOR ASSEMBLY INCLUDING SAME

(71) Applicants: Hyundai Motor Company, Seoul (KR); Kia Corporation, Seoul (KR)

(72) Inventor: Jin Hyeok YOO, Hwaseong-Si (KR)

(21) Appl. No.: 19/013,879

(22) Filed: Jan. 8, 2025

(30) Foreign Application Priority Data
Oct. 10, 2024 (KR) 10-2024-0137234

(51) Int. Cl. H01M 8/0276; H01M 8/0254; H01M 8/0267

(52) U.S. Cl. CPC H01M 8/0276; H01M 8/0254; H01M 8/0267

(57) ABSTRACT

A fuel cell separator including at least one separator provided with a plurality of manifolds and a reaction area, in which the at least one separator includes a forming portion protruding in a direction from a reaction surface of the at least one separator toward a cooling surface of the at least one separator, the forming portion extends along a first direction in which the manifolds disposed on one side of the at least one separator are provided, and the forming portion is provided at a position where a gasket disposed on the reaction surface is discontinuously disposed in the first direction.

### CROSS-REFERENCE TO RELATED APPLICATION

The present application claims priority to Korean Patent Application No. 10-2024-0137234, filed on Oct. 10, 2024, the entire contents of which is incorporated herein for all purposes by this reference.

### BACKGROUND OF THE PRESENT DISCLOSURE

### Field of the Present Disclosure

The present disclosure relates to a fuel cell separator having a protruding structure for obtaining airtight performance of unit cells forming a fuel cell stack, and to a fuel cell separator assembly including the same.

### Description of Related Art

A fuel cell is a type of power generation device configured to convert chemical energy of fuel into electrical energy by electrochemical reaction in a stack thereof, and may be used to supply power for industrial, household, and vehicle driving, as well as to power small electronic products such as portable devices. Recently, the use of a fuel cell has been gradually increasing as a high-efficiency clean energy source.

Each of unit cells that form a typical fuel cell stack includes a membrane-electrode assembly (MEA) located in the innermost position thereof. The membrane-electrode assembly is composed of a polymer electrolyte membrane that can transport hydrogen protons, and catalyst layers applied onto both sides of the electrolyte membrane so that hydrogen and oxygen may react, namely a fuel pole (an anode) and an air pole (a cathode).

A pair of gas diffusion layers (GDL) is stacked on both external surfaces of the membrane-electrode assembly, and a separator assembly with a flow field formed to supply fuel and discharge water generated by reaction is disposed on the external surfaces of the gas diffusion layers with a gasket therebetween. The separator assembly is formed by joining an anode separator disposed on the anode and a cathode separator disposed on the cathode to face each other. The anode separator and the cathode separator are joined and integrated, so that manifolds communicate with each other and are configured with similar shapes so that the reaction surfaces are disposed at the same position thereof. Also, an end plate is attached to each of both outermost surfaces of the stacked unit cells by the end plate to support and fix each of the above configurations.

The gasket is disposed along the periphery of the multiple manifolds, but includes a plurality of supports extending toward the central area of the separator. The gasket includes a first gasket surrounding the periphery of the multiple manifolds, a second gasket disposed along the edge portion of the separator, and supports extending in a direction toward the central area of the separator from the manifolds. The supports provided on both the anode separator and the cathode separator are disposed in a position of vertical overlap. Although surface pressure of the stacked structure of the separators is relatively high in the area where the supports overlap, there occurs a problem in that the surface pressure of the stacked structure of the separators becomes low in the area where the supports are not provided.

The information included in this Background of the present disclosure is only for enhancement of understanding of the general background of the present disclosure and may not be taken as an acknowledgement or any form of suggestion that this information forms the related art already known to a person skilled in the art.

### BRIEF SUMMARY

Various aspects of the present disclosure are directed to providing a fuel cell separator including forming portions for obtaining airtight performance of unit cells forming a fuel cell stack and reinforcing the unit cells, and a fuel cell separator assembly including the same.

An exemplary embodiment of the present disclosure provides a fuel cell separator, including at least one separator provided with a plurality of manifolds and a reaction area, in which the at least one separator includes a forming portion protruding in a direction from a reaction surface of the at least one separator toward a cooling surface of the at least one separator, the forming portion extends along a first direction in which the plurality of manifolds disposed on one side of the at least one separator is provided, and the forming portion is provided at a position where a gasket disposed on the reaction surface is discontinuously disposed in the first direction.

In an exemplary embodiment of the present disclosure, the forming portion may include a concave portion which is a region where the reaction surface is recessed, and a sealing portion may be disposed in the concave portion.

In an exemplary embodiment of the present disclosure, the gasket may include a main gasket disposed along a perimeter of the plurality of manifolds and a support extending from the main gasket toward the reaction area, and the forming portion may be provided at a position where a plurality of supports is provided in the first direction.

In an exemplary embodiment of the present disclosure, the at least one separator may further include a modified forming portion protruding toward the support, and the forming portion and the modified forming portion may be alternately disposed in the first direction.

In an exemplary embodiment of the present disclosure, the forming portion may be disposed between two adjacent supports, and the modified forming portion may extend as wide as the support based on the first direction.

In an exemplary embodiment of the present disclosure, the at least one separator may include an additional forming portion provided at a position corresponding to the main gasket disposed between the reaction area and each of the manifolds, and the additional forming portion may protrude from the cooling surface toward the reaction surface.

In an exemplary embodiment of the present disclosure, a plurality of forming portions may be provided between the reaction area and each of some manifolds through which reaction gases flow among the plurality of manifolds, and the length of each of the forming portions based on the first direction may be greater than the length of each of the manifolds provided at corresponding positions.

Another exemplary embodiment of the present disclosure provides a fuel cell separator assembly, including a first separator including a first forming portion protruding from a reaction surface toward a cooling surface, a second separator including a second forming portion protruding from a reaction surface toward a cooling surface, a first gasket disposed on the reaction surface of the first separator, a second gasket disposed on the reaction surface of the second separator, and a third gasket disposed on the cooling surface of the second separator, in which the first forming portion and the second forming portion extend along a first direction in which a plurality of manifolds disposed on one side of the first separator or the second separator is provided.

In an exemplary embodiment of the present disclosure, the first forming portion may be provided at a position where the first gasket is discontinuously disposed in the first direction, and the second forming portion may be provided at a position where the second gasket is discontinuously disposed in the first direction.

In an exemplary embodiment of the present disclosure, the second separator may include a third forming portion protruding from the cooling surface toward the reaction surface.

In an exemplary embodiment of the present disclosure, the third forming portion may be disposed adjacent to the plurality of manifolds compared to the second forming portion.

In an exemplary embodiment of the present disclosure, the first gasket may include a first main gasket disposed along a perimeter of the plurality of manifolds and a first support extending from the first main gasket toward a reaction area of the first separator, the second gasket may include a second main gasket disposed along a perimeter of the plurality of manifolds and a second support extending from the second main gasket toward a reaction area of the second separator, the first forming portion may be provided at a position where a plurality of first supports is provided in the first direction, and the second forming portion may be provided at a position where a plurality of second supports is provided in the first direction.

In an exemplary embodiment of the present disclosure, the second separator may include a third forming portion protruding from the cooling surface toward the reaction surface, and the third forming portion may be provided at a position overlapping the second main gasket.

In an exemplary embodiment of the present disclosure, the third gasket may be disposed on the second forming portion, and the second gasket may be disposed on the third forming portion.

In an exemplary embodiment of the present disclosure, a part of the second forming portion may be exposed through the third gasket, the first separator and the second separator may be alternately stacked, and the part of the second forming portion exposed through the third gasket may be in contact with the first forming portion protruding toward the cooling surface of the second separator.

In an exemplary embodiment of the present disclosure, a part of the third forming portion may be exposed through the second gasket, and the exposed part of the third forming portion may be in contact with a sub-gasket disposed between the first separator and the second separator or the first gasket disposed on the first separator.

In an exemplary embodiment of the present disclosure, the first separator may include a fourth forming portion protruding from the cooling surface toward the reaction surface, and the fourth forming portion may be provided at a position overlapping the first main gasket.

In an exemplary embodiment of the present disclosure, the first separator may include a flow hole through which a reaction gas flows, and the flow hole may be provided between the first forming portion and the fourth forming portion.

In an exemplary embodiment of the present disclosure, the first forming portion may include a first concave portion which is a region where the reaction surface of the first separator is recessed, the second forming portion may include a second concave portion which is a region where the reaction surface of the second separator is recessed, and the first concave portion and the second concave portion are filled with an elastic material.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 shows a stacked structure of a fuel cell stack according to an exemplary embodiment of the present disclosure;

FIG. 2 shows a reaction surface of an anode separator according to an exemplary embodiment of the present disclosure;

FIG. 3 shows a cooling surface of the anode separator according to an exemplary embodiment of the present disclosure;

FIG. 4 shows a reaction surface of a cathode separator according to an exemplary embodiment of the present disclosure;

FIG. 5 shows a cooling surface of the cathode separator according to an exemplary embodiment of the present disclosure;

FIG. 6 is a cross-sectional view along line A-A′ of FIG. 2;

FIG. 7 is a cross-sectional view along line B-B′ of FIG. 2;

FIG. 8 is a cross-sectional view along line C-C′ of FIG. 4;

FIG. 9 is a cross-sectional view along line D-D′ of FIG. 4;

FIG. 10 is a cross-sectional view of a separator assembly according to an exemplary embodiment of the present disclosure;

FIG. 11 shows a modification of area A of FIG. 2;

FIG. 12 shows a forming portion provided on the separator of FIG. 11;

FIG. 13 and FIG. 14 show modifications of the forming portion applied to the cathode separator;

FIG. 15 is a cross-sectional view of a separator assembly to which the forming portion of FIG. 13 is applied;

FIG. 16 shows a modification of a first gasket disposed on the anode separator according to an exemplary embodiment of the present disclosure;

FIG. 17 shows a modification of a second gasket disposed on the cathode separator according to an exemplary embodiment of the present disclosure; and

FIG. 18 is a cross-sectional view along line E-E′ of FIG. 16 and FIG. 17.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

The advantages and features of the present disclosure and the methods of achieving the same will become apparent with reference to various exemplary embodiments described in detail below together with the accompanying drawings. However, the present disclosure is not limited to the exemplary embodiments included below, but may be implemented in various different forms. These embodiments are provided only to make the present disclosure complete and to fully inform those skilled in the art of the scope of the present disclosure, and the present disclosure is merely defined by the scope of the claims. Throughout the specification, the same reference numerals designate the same components.

Furthermore, the reason why the names of the components herein are divided into first, second, etc. is to distinguish them when the names of the components are the same, and the order in the description below is not necessarily limited to that order.

The detailed description is directed to illustrate the present disclosure. It should also be understood that the foregoing description is directed to illustrate exemplary embodiments of the present disclosure and that the present disclosure may be used in a variety of other combinations, modifications, and environments. Changes or modifications are possible within the scope of the concept of the present disclosure herein, the scope equivalent to the described disclosure, and/or the scope of technology or knowledge in the art. These embodiments are used to describe the best state for implementing the technical idea of the present disclosure, and various modifications required for specific application fields and utilizes of the present disclosure are also possible. Therefore, the detailed description is not intended to limit the present disclosure to the included exemplary embodiments of the present disclosure. Moreover, the appended claims should be construed to include other embodiments.

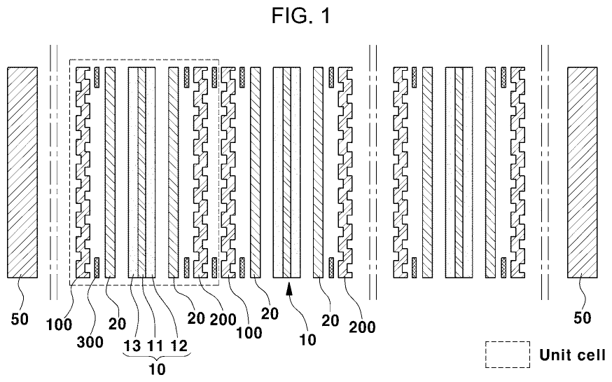

FIG. 1 shows the stacked structure of a fuel cell stack according to an exemplary embodiment of the present disclosure.

Referring to FIG. 1, a fuel cell stack may be composed of a plurality of unit cells. Each of the unit cells may include a membrane-electrode assembly (MEA) 10, a pair of gas diffusion layers (GDL) 20 disposed on the membrane-electrode assembly 10, a pair of separators 100, 200 disposed on the pair of gas diffusion layers 20, and a gasket structure 300 disposed on the pair of separators 100, 200.

The membrane-electrode assembly 10 may be composed of a polymer electrolyte membrane 11 configured for transporting protons, and catalyst layers applied onto respective sides of the electrolyte membrane 11 so that hydrogen and oxygen may react, namely an anode 12 and a cathode 13.

The pair of gas diffusion layers 20 may be stacked on both external surfaces of the membrane-electrode assembly 10 where the anode 12 and the cathode 13 are located. On the external surfaces of the gas diffusion layers 20, the pair of separators 100, 200 with a flow field formed to supply fuel and discharge water generated by reaction may be provided with an airtight gasket 300 therebetween.

The pair of separators 100, 200 may include an anode separator 100 disposed on the anode and a cathode separator 200 disposed on the cathode. Hydrogen and air, which are reaction gases, may be introduced into the fuel cell stack through anode separators 100 and cathode separators 200, whereby power may be generated by electrochemical reaction in the membrane-electrode assembly 10, and water (hereinafter referred to as “product water”) may be generated as a byproduct thereof. Each of the pair of separators 100, 200 may include a reaction surface through which a reaction gas flows and a cooling surface through which product water flows.

To the fuel cell stack, hydrogen and air, which are reaction gases, as well as coolant for cooling, are supplied. The reaction gases and coolant flowing in the fuel cell stack may be introduced or discharged through manifolds formed in the separators 100, 200.

The anode separator 100 and the cathode separator 200 are joined and integrated, whereby the manifolds may communicate with each other, and the reaction areas of the anode separator 100 and the cathode separator 200 may be formed at positions facing each other. In the anode separator 100 and the cathode separator 200, the manifolds and the reaction area are the spaces in which reaction gases or coolant are introduced, discharged, or flow, and for airtightness, an sealing line along the perimeter of the manifolds may be formed by the gasket structure 300.

An end plate 50 may be attached to each of both outermost surfaces of the unit cells to support and fix the unit cells.

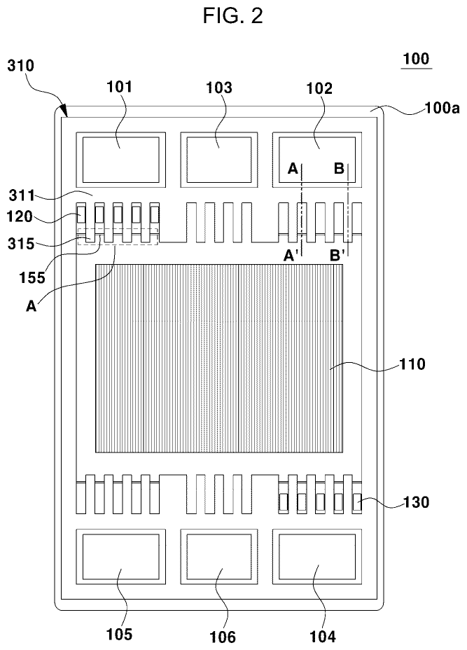

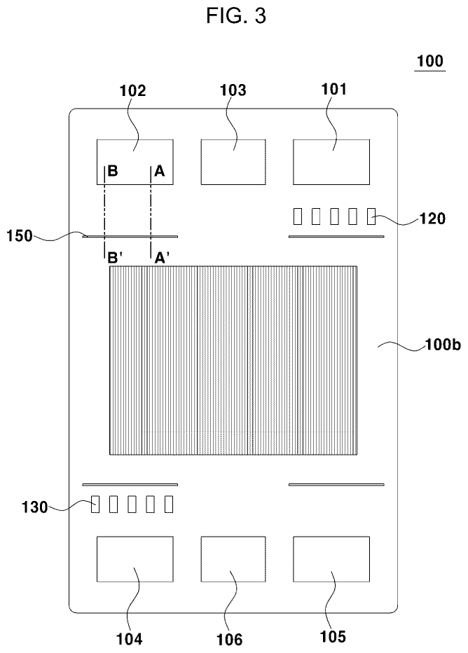

FIG. 2 shows the reaction surface of the anode separator according to an exemplary embodiment of the present disclosure, and FIG. 3 shows the cooling surface of the anode separator according to an exemplary embodiment of the present disclosure.

Referring to FIG. 2 and FIG. 3, the anode separator 100 may include a reaction surface 100a and a cooling surface 100b. The reaction surface 100a of the anode separator 100 may include a reaction area 110 where electrochemical reaction of reaction gases occurs. The anode separator 100 may be provided with a plurality of manifolds 101, 102, 103, 104, 105, 106 through which reaction gases or coolant are introduced or discharged. The anode separator 100 may be provided with first flow holes 120 for introducing the reaction gases fed from the manifolds 101, 102, 103, 104, 105, 106 into the reaction area 110 and second flow holes 130 for discharging the reaction gases from the reaction area 110.

For example, the manifolds 101, 102, 103, 104, 105, 106 may include inlet manifolds 101, 105 through which reaction gases are introduced, outlet manifolds 102, 104 through which reaction gases are discharged, and coolant manifolds 103, 106 through which coolant is introduced or discharged. The inlet manifolds 101, 105 may include a first inlet manifold 101 into which hydrogen is introduced and a second inlet manifold 105 into which oxygen is introduced. The outlet manifolds 102, 104 may include a first outlet manifold 104 from which hydrogen is discharged and a second outlet manifold 102 from which oxygen is discharged.

A first gasket 310 may be disposed on the reaction surface 100a of the anode separator 100. The first gasket 310 may include a first main gasket 311 disposed along the perimeter of the manifolds 101, 102, 103, 104, 105, 106 and a first support 315 extending from the first main gasket 311 toward the reaction area 110. A plurality of first supports 315 may be provided in the space between each of the manifolds 101, 102, 103, 104, 105, 106 and the reaction area 110. The first flow holes 120 may be formed between the first supports 315 extending from the first inlet manifold 101 to the reaction area 110. The second flow holes 130 may be formed between the first supports 315 extending from the first outlet manifold 104 to the reaction area 110.

The anode separator 100 may include a first forming portion 150 that protrudes in a direction from the reaction surface 100a toward the cooling surface 100b. The first forming portion 150 may be a portion in which a part of the anode separator 100 is curved. The first forming portion 150 may protrude onto the cooling surface 100b of the anode separator 100. A first concave portion 155, which is a recessed portion, may be formed on the reaction surface 100a of the anode separator 100 by the first forming portion 150.

The first forming portion 150 may extend along a first direction in which the manifolds 101, 102, 103 or 104, 105, 106 disposed on one side based on the reaction area 110 or on one side of the anode separator 100 are provided. The first forming portion 150 may be provided at a position where the first gasket 310 is discontinuously disposed on the reaction surface 100a. The first forming portion 150 may be provided at a position where the first supports 315 are disposed on the reaction surface 100a. The first supports 315 may be discontinuously disposed on the first concave portion 155 formed on the reaction surface 100a by the first forming portion 150. The first supports 315 may extend in a direction perpendicular to the first direction.

A plurality of first forming portions 150 or a plurality of first concave portions 155 may be provided in the space between the reaction area 110 and each of some manifolds 101, 102, 104, 105 through which reaction gases flow among the manifolds 101, 102, 103, 104, 105, 106. For example, four first forming portions 150 and four first concave portions 155 may be provided. The first forming portion 150 or the first concave portion 155 may not be formed in the space between the coolant manifolds 103, 106 and the reaction area 110. The first forming portion 150 or the first concave portion 155 may be located adjacent to the reaction area 110 based on positions where the first flow holes 120 and the second flow holes 130 are disposed. The length of each of the first forming portions 150 based on the first direction may be greater than the length of each of some manifolds 101, 102, 104, 105 provided at corresponding positions. For example, the length of the first forming portion 150 provided adjacent to the first inlet manifold 101 may be greater than the length of the first inlet manifold 101 based on the first direction. The first forming portions 150 provided in the first direction may be spaced apart from each other.

According to an exemplary embodiment of the present disclosure, warping of the anode separator 100 may be reduced by the first forming portions 150 including a curved shape. Although there is a problem in that the surface pressure of the unit cell becomes low in an area where the first supports 315 are not provided among the areas adjacent to the manifolds 101, 102, 103, 104, 105, 106 through which reaction gases or coolant flow in and out, the effect of enhancing surface pressure of the unit cell may be generated by the first forming portions 150.

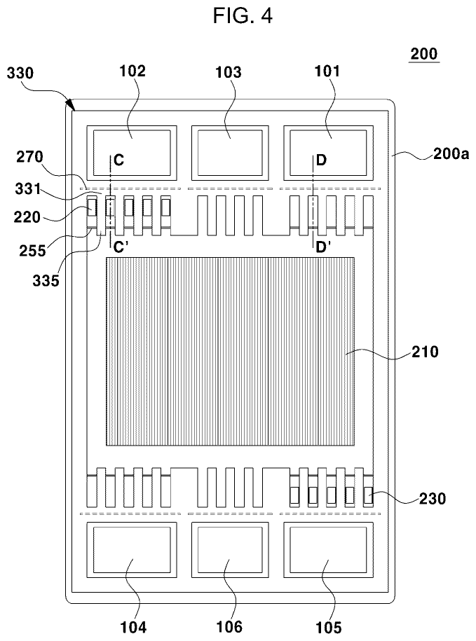

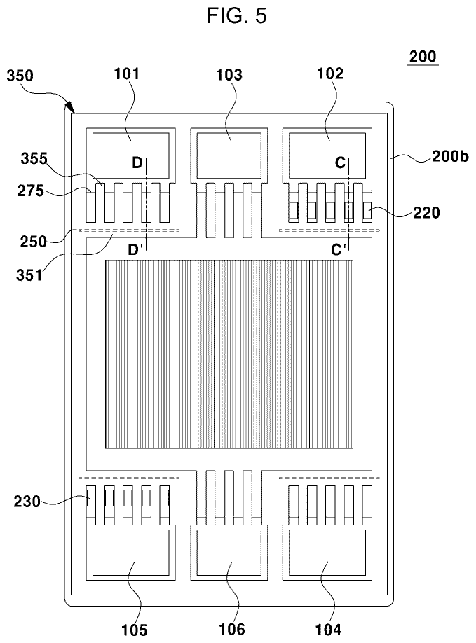

FIG. 4 shows the reaction surface of the cathode separator according to an exemplary embodiment of the present disclosure, and FIG. 5 shows the cooling surface of the cathode separator according to an exemplary embodiment of the present disclosure.

Referring to FIG. 4 and FIG. 5, the cathode separator 200 may include a reaction surface 200a and a cooling surface 200b. The reaction surface 200a of the cathode separator 200 may include a reaction area 210 where electrochemical reaction of reaction gases occurs. The cathode separator 200 may be provided with a plurality of manifolds 101, 102, 103, 104, 105, 106 through which reaction gases or coolant are introduced or discharged.

The cathode separator 200 may be provided with third flow holes 220 for discharging the reaction gases fed from the manifolds 101, 102, 103, 104, 105, 106 from the reaction area 210 and fourth flow holes 230 for introducing the reaction gases into the reaction area 210.

A second gasket 330 may be disposed on the reaction surface 200a of the cathode separator 200, and a third gasket 350 may be disposed on the cooling surface 200b of the cathode separator 200. The second gasket 330 may include a second main gasket 331 disposed along the perimeter of the manifolds 101, 102, 103, 104, 105, 106 and a second support 335 extending from the second main gasket 331 toward the reaction area 210. A plurality of second supports 335 may be provided in the space between each of the manifolds 101, 102, 103, 104, 105, 106 and the reaction area 210. The third flow holes 220 may be formed between the second supports 335 extending from the first inlet manifold 101 to the reaction area 210. The fourth flow holes 230 may be formed between the second supports 335 extending from the first outlet manifold 104 to the reaction area 210.

The third gasket 350 may include a third main gasket 351 disposed along the perimeter of some manifolds 101, 102, 104, 105 through which reaction gases flow in and out among the manifolds 101, 102, 103, 104, 105, 106, and a third support 355 extending from the third main gasket 351 toward each of the manifolds 101, 102, 103, 104, 105, 106. The third support 355 may extend toward each of some manifolds 101, 102, 104, 105 from a part of the third main gasket 351 extending in the first direction while being adjacent to the center portion of the cooling surface 200b of the cathode separator 200. Here, a gasket structure extending in the first direction is not provided between the central area of the cathode separator 200 and the coolant manifolds 103, 106, but the third support 355 extending in a direction perpendicular to the first direction may be provided.

A plurality of third supports 355 may be provided in the space between the central area of the cooling surface 200b and each of the manifolds 101, 102, 103, 104, 105, 106. The third flow holes 220 may be formed between the second supports 355 located adjacent to the second outlet manifold 102. The fourth flow holes 230 may be formed between the second supports 355 located adjacent to the second inlet manifold 105.

The cathode separator 200 may include a second forming portion 250 that protrudes in a direction from the reaction surface 200a toward the cooling surface 200b. The second forming portion 250 may be a portion in which a part of the cathode separator 200 is curved. The second forming portion 250 may protrude onto the cooling surface 200b of the cathode separator 200. A second concave portion 255, which is a recessed portion, may be formed on the reaction surface 200a of the cathode separator 200 by the second forming portion 250.

The cathode separator 200 may include a third forming portion 270 that protrudes in a direction from the cooling surface 200b toward the reaction surface 200a. The third forming portion 270 may be a portion in which a part of the cathode separator 200 is curved. The third forming portion 270 may protrude onto the reaction surface 200a of the cathode separator 200. A third concave portion 275, which is a recessed portion, may be formed on the cooling surface 200b of the cathode separator 200 by the third forming portion 270.

The second forming portion 250 and the third forming portion 270 may extend along the first direction in which the manifolds 101, 102, 103 or 104, 105, 106 disposed on one side of the anode separator 100 are provided. The second forming portion 250 may be provided at a position where the second gasket 330 is discontinuously disposed on the reaction surface 200a. The second forming portion 250 may be provided at a position where a plurality of second supports 335 is disposed on the reaction surface 200a. The second supports 335 may be discontinuously disposed on the second concave portion 255 formed on the reaction surface 200a by the second forming portion 250. The third forming portion 270 may be provided at a position where the third gasket 350 is discontinuously disposed on the cooling surface 200b. The third forming portion 270 may be provided at a position where a plurality of third supports 355 is disposed on the cooling surface 200b. The third supports 355 may be discontinuously disposed on the third concave portion 275 formed on the cooling surface 200b by the third forming portion 270.

A plurality of second forming portions 250 or a plurality of second concave portions 255 may be provided between the reaction area 210 and each of some manifolds 101, 102, 104, 105 through which reaction gases flow among the manifolds 101, 102, 103, 104, 105, 106. For example, four second forming portions 250 and four second concave portions 255 may be provided. The second forming portion 250 or the second concave portion 255 may not be provided between the coolant manifolds 103, 106 and the reaction area 210. The second forming portion 250 or the second concave portion 255 may be located adjacent to the reaction area 210 based on positions where the third flow holes 220 and the fourth flow holes 230 are disposed. The length of each of the second forming portions 250 based on the first direction may be greater than the length of each of some manifolds 101, 102, 104, 105 provided at corresponding positions. For example, the length of the second forming portion 250 provided adjacent to the first inlet manifold 101 may be greater than the length of the first inlet manifold 101 based on the first direction. The second forming portions 250 provided in the first direction may be spaced apart from each other.

A plurality of third forming portions 270 or a plurality of third concave portions 275 may be provided between the manifolds 101, 102, 103, 104, 105, 106 and the reaction area 210 of the cathode separator 200. For example, six third forming portions 270 or six third concave portions 275 may be provided. The third forming portions 270 or the third concave portions 275 may be located adjacent to the manifolds 101, 102, 103, 104, 105, 106 compared to the second forming portions 250 or the second concave portions 255. Accordingly, the manifolds 101, 102, 103, 104, 105, 106, the third forming portions 270, and the second forming portions 250 may be sequentially located in a direction from one side of the cathode separator 200 to the remaining side thereof. The third forming portions 270 or the third concave portions 275 may be located adjacent to the manifolds 101, 102, 103, 104, 105, 106 based on positions where the third flow holes 220 and the fourth flow holes 230 are disposed. The length of each of the third forming portions 270 based on the first direction may be greater than the length of each of some manifolds 101, 102, 104, 105 provided at corresponding positions. For example, the length of the third forming portion 270 provided adjacent to the first inlet manifold 101 may be greater than the length of the first inlet manifold 101 based on the first direction. The length of each of the second forming portions 250 may be the same as the length of each of the third forming portions 270 provided at corresponding positions based on the manifolds 101, 102, 103, 104, 105, 106. For example, the length of the third forming portion 270 provided adjacent to the first inlet manifold 101 may be the same as the length of the second forming portion 250 provided adjacent to the first inlet manifold 101. However, the length of the third forming portion 270 provided adjacent to the first inlet manifold 101 may be greater than the length of the third forming portion 270 provided adjacent to the coolant manifolds 103, 106. Also, the length of the third forming portion 270 provided adjacent to the coolant manifolds 103, 106 may be less than the length of the second forming portion 250. The third forming portions 270 provided in the first direction may be spaced apart from each other.

Based on the separator stacking direction from the reaction surface 200a of the cathode separator 200 toward the cooling surface 200b thereof, the second forming portion 250 may be disposed to overlap the third main gasket 351, and the third forming portion 270 may be disposed to overlap the second main gasket 331. The second main gasket 331 may be located adjacent to some manifolds 101, 102, 104, 105 compared to the third main gasket 351, and the third forming portion 270 may be located adjacent to some manifolds 101, 102, 104, 105 compared to the second forming portion 250. The third forming portion 270 and the second concave portion 255 may be provided on the reaction surface 200a of the cathode separator 200, and the third concave portion 275 and the second forming portion 250 may be provided on the cooling surface 200b of the cathode separator 200.

According to an exemplary embodiment of the present disclosure, warping of the cathode separator 200 may be reduced by the second forming portion 250 and the third forming portion 270 including a curved shape. Although there is a problem in that the surface pressure of the unit cell becomes low in an area where the second supports 335 and the third supports 355 are not provided among areas adjacent to the manifolds 101, 102, 103, 104, 105, 106 through which reaction gases or coolant flow in and out, the effect of enhancing surface pressure of the unit cell may be generated by the second forming portion 250 and the third forming portion 270.

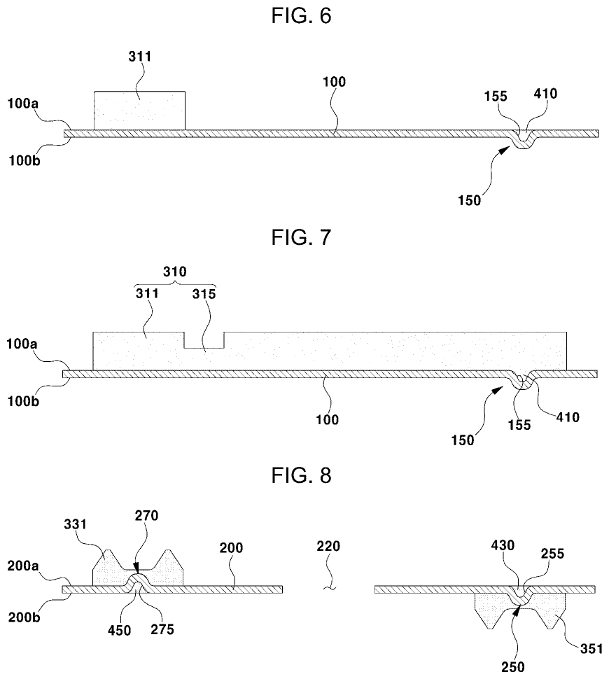

FIG. 6 is a cross-sectional view along line A-A′ of FIG. 2.

Referring to FIGS. 2 and 6, in the area where the first support 315 is not provided, the first forming portion 150 may protrude toward the cooling surface 100b rather than the reaction surface 100a where the first main gasket 311 is disposed. The first concave portion 155 provided on the reaction surface 100a of the anode separator 100 by the shape of the first forming portion 150 may be filled with a first sealing portion 410. The first concave portion 155 may be a region which is recessed based on the reaction surface 100a of the anode separator 100. The first sealing portion 410 may be made of an elastic material, preferably the same rubber material as the first gasket 310.

According to an exemplary embodiment of the present disclosure, as the first concave portion 155 is filled with the first sealing portion 410, rigidity of the first forming portion 150 may be improved, and as the rigidity of the first forming portion 150 is improved, structural stability of the anode separator 100 may be improved.

FIG. 7 is a cross-sectional view along line B-B′ of FIG. 2.

Referring to FIGS. 2 and 7, in the area where the first support 315 is provided, the first forming portion 150 may protrude toward the cooling surface 100b rather than the reaction surface 100a where the first main gasket 311 is disposed. The first concave portion 155 provided on the reaction surface 100a of the anode separator 100 by the shape of the first forming portion 150 may be filled with a first sealing portion 410. The first sealing portion 410 may be in contact with the first support 315.

FIG. 8 is a cross-sectional view along line C-C′ of FIG. 4.

Referring to FIGS. 4 and 8, the second support 335 and the third support 355 may not be provided on the cathode separator 200 in the area where the third flow hole 220 is provided. The second forming portion 250 may be provided on the cooling surface 200b of the cathode separator 200, and the third forming portion 270 may be provided on the reaction surface 200a of the cathode separator 200. The second forming portion 250 may protrude from the reaction surface 200a toward the cooling surface 200b, and the third forming portion 270 may protrude from the cooling surface 200b toward the reaction surface 200a. The third main gasket 351 may be disposed on the second forming portion 250, and the second main gasket 331 may be disposed on the third forming portion 270. The second forming portion 250 may not be externally exposed due to the third main gasket 351, and the third forming portion 270 may not be externally exposed due to the second main gasket 331. The second concave portion 255 provided on the reaction surface 200a of the cathode separator 200 by the shape of the second forming portion 250 may be filled with a second sealing portion 430. The second sealing portion 430 may be made of an elastic material, preferably the same rubber material as the third gasket 350. The third concave portion 275 provided on the cooling surface 200b of the cathode separator 200 by the shape of the third forming portion 270 may be filled with a third sealing portion 450. The third sealing portion 450 may be made of an elastic material, preferably the same rubber material as the second gasket 330. The second concave portion 255 may be a region which is recessed based on the reaction surface 200a of the cathode separator 200. The third concave portion 275 may be a region which is recessed based on the cooling surface 200b of the cathode separator 200.

The second forming portion 250 and the third forming portion 270 may protrude in a direction opposite to the space in which air is introduced or discharged through the third flow hole 220. The third forming portion 270 located adjacent to the manifolds 101, 102, 103, 104, 105, 106 based on the third flow hole 220 may protrude from the cooling surface 200b toward the reaction surface 200a, and the second forming portion 250 located adjacent to the reaction area 210 based on the third flow hole 220 may protrude from the reaction surface 200a toward the cooling surface 200b.

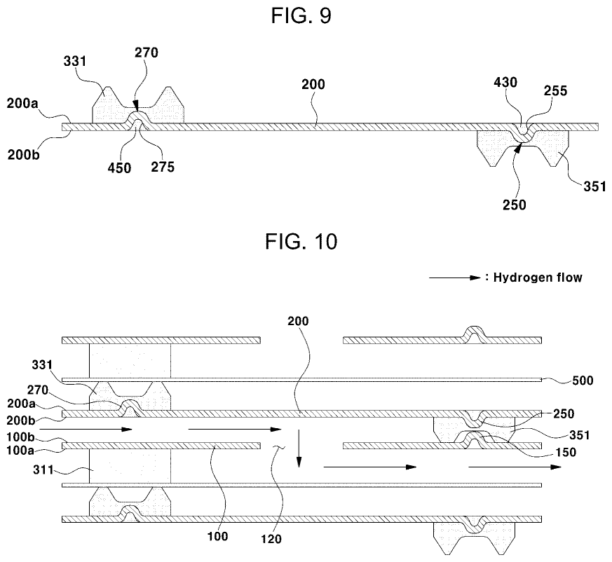

FIG. 9 is a cross-sectional view along line D-D′ of FIG. 4. For the sake of brevity, a redundant description of FIG. 8 is omitted.

Referring to FIGS. 4 and 9, the second forming portion 250 may be provided on the cooling surface 200b of the cathode separator 200, and the third forming portion 270 may be provided on the reaction surface 200a of the cathode separator 200. The third main gasket 351 may be disposed on the second forming portion 250, and the second main gasket 331 may be disposed on the third forming portion 270.

According to an exemplary embodiment of the present disclosure, as the second concave portion 255 and the third concave portion 275 are filled with the second sealing portion 430 and the third sealing portion 450, respectively, rigidity of the second forming portion 250 and the third forming portion 270 may be improved, and as the rigidity of the second forming portion 250 and the third forming portion 270 is improved, structural stability of the cathode separator 200 may be improved.

FIG. 10 is a cross-sectional view of a separator assembly according to an exemplary embodiment of the present disclosure.

Referring to FIGS. 2, 4, and 10, hydrogen may flow through the first flow hole 120 in a structure in which a plurality of separators 100, 200 is stacked. The third forming portion 270 located adjacent to the manifolds 101, 102, 103, 104, 105, 106 based on the first flow hole 120 may protrude from the cooling surface 200b toward the reaction surface 200a, so that rigidity of the cathode separator 200 may be improved without the flow of hydrogen being obstructed by the third forming portion 270. The first forming portion 150 located adjacent to the reaction area 110 based on the first flow hole 120 may protrude from the reaction surface 100a toward the cooling surface 200b, so that rigidity of the anode separator 100 may be improved without the flow of hydrogen being obstructed by the first forming portion 150. Furthermore, the first forming portion 150 may be in direct contact with the third main gasket 351 provided on the second forming portion 250, increasing surface pressure between the separators.

Furthermore, even when analyzing the stacked structure of the separators 100, 200 according to air flow, the direction in which the air flows and the direction in which the forming portions 150, 250, 270 protrude do not coincide with each other, so that the surface pressure between the separators may be increased without the air flow being obstructed by the forming portions 150, 250, 270.

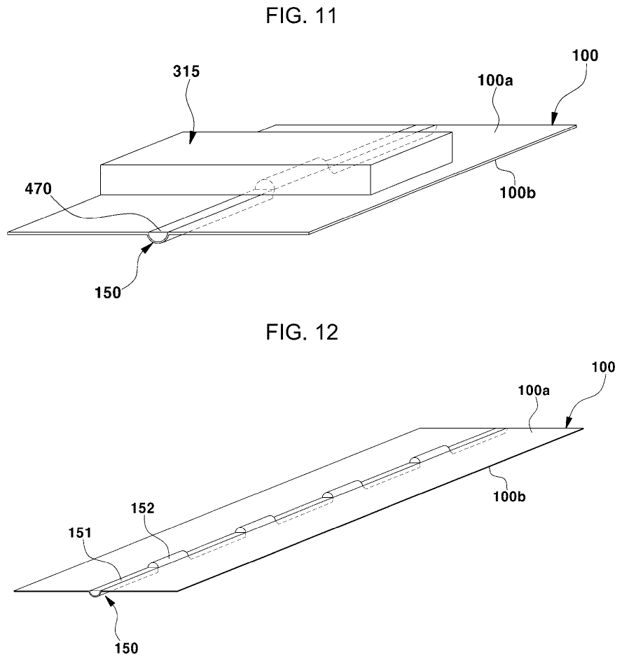

FIG. 11 shows a modification of area A of FIG. 2, and FIG. 12 shows the forming portion provided on the separator of FIG. 11.

Referring to FIG. 11 and FIG. 12, the first forming portion 150 provided in area A where the first supports 315 are discontinuously disposed may include basic forming portions 151 and modified forming portions 152. Each of the basic forming portions 151 may protrude from the reaction surface 100a of the anode separator 100 toward the cooling surface 100b thereof. Each of the modified forming portions 152 may protrude from the cooling surface 100b of the anode separator 100 toward the reaction surface 100a thereof. The basic forming portion 151 may protrude toward the cooling surface 100b opposite to the reaction surface 100a on which the first supports 315 are disposed, and the modified forming portion 152 may protrude toward the reaction surface 100a on which the first supports 315 are disposed.

The modified forming portion 152 may protrude toward each of the first supports 315. The first supports 315 may be formed on the protruding modified forming portions 152. Accordingly, in area A, basic forming portions 151 and modified forming portions 152 may be alternately disposed to correspond to the arrangement structure of the first supports 315 that are disposed discontinuously in the first direction. The basic forming portions 151 and the modified forming portions 152 protruding in different directions may be alternately disposed in the first direction. Each basic forming portion 151 may be disposed between two adjacent first supports 315, and each modified forming portion 152 may be disposed between two adjacent basic forming portions 151. The modified forming portion 152 may extend as wide as the first support 315 based on the first direction. Briefly, the modified forming portion 152 may have the same length as the first support 315 based on the first direction.

Unlike the exemplary embodiment described above, the same shape as the modified forming portion 152 of the first forming portion 150 may be applied to the second forming portion 250 and the third forming portion 270 provided on the cathode separator 200 illustrated in FIG. 4 and FIG. 5.

According to an exemplary embodiment of the present disclosure, although the first support 315 may deteriorate by contact with the gasket provided on the cathode separator and may be lowered in height due to the deterioration, since the first support 315 is formed on the modified forming portion 152, the height of the first support 315 cannot be less than the height of the modified forming portion 152. Briefly, the modified forming portion 152 may serve as a frame of the first support 315. Therefore, the problem of the surface pressure between the separators becoming low due to deterioration of the first support 315 may be alleviated by the modified forming portion 152.

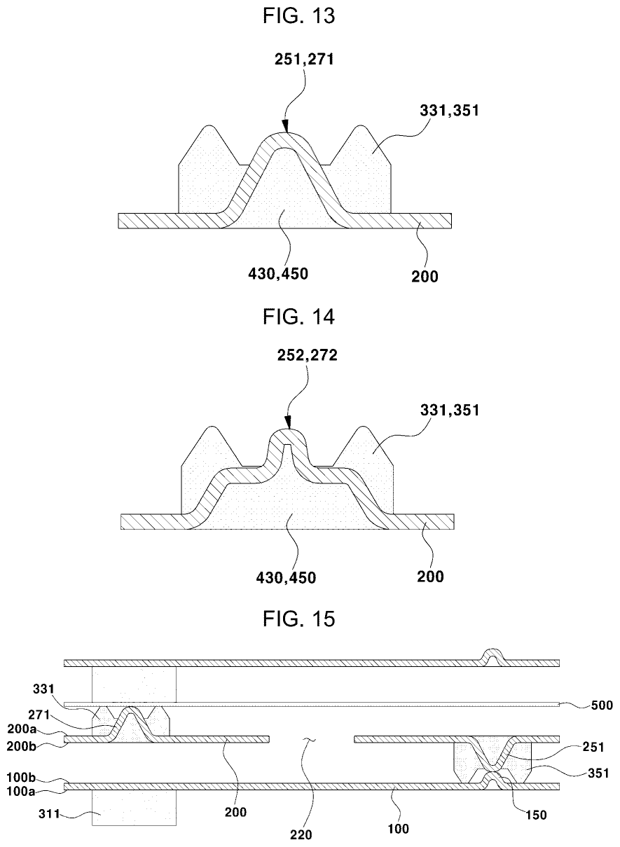

FIG. 13 and FIG. 14 show modifications of the forming portion applied to the cathode separator.

Referring to FIG. 13, to improve the rigidity of a second forming portion 251 or a third forming portion 271 provided on the cathode separator and the structural stability between the separators, the second forming portion 251 or the third forming portion 271 may be provided in a shape in which a part of the second forming portion 251 or the third forming portion 271 is externally exposed of the second main gasket 331 or the third main gasket 351. The second forming portion 251 may be configured to pass through the third main gasket 351, and accordingly, the amount of the sealing material loaded in the rear surface of the second forming portion 251 may increase. A second sealing portion 430 may be formed on the rear surface of the second forming portion 251, and a third sealing portion 450 may be formed on the rear surface of the third forming portion 271. Also, the third forming portion 271 may be configured to pass through the second main gasket 331, and accordingly, the amount of the sealing material loaded in the rear surface of the third forming portion 271 may increase. Thus, the rigidity of the second forming portion 251 or the third forming portion 271 may be relatively increased.

Referring to FIG. 14, the shape of a second forming portion 252 or a third forming portion 272 may be changed so that the amount of the sealing material loaded in the rear surface of the second forming portion 252 or the third forming portion 272 increases. The cross-section of the second forming portion 251 or the third forming portion 271 illustrated in FIG. 13 may include a triangular shape, but the cross-section of the modified second forming portion 252 or the modified third forming portion 272 may include a trapezoidal shape with a part thereof externally exposed of the second main gasket 331 or the third main gasket 351. As the second forming portion 252 or the third forming portion 272 is provided in a trapezoidal shape as opposed to a triangular shape, the amount of the sealing material loaded in the rear surface of the second forming portion 252 or the third forming portion 272 may be relatively increased. Accordingly, the rigidity of the second forming portion 252 or the third forming portion 272 illustrated in FIG. 14 may be increased compared to the rigidity of the second forming portion 251 or third forming portion 271 illustrated in FIG. 13.

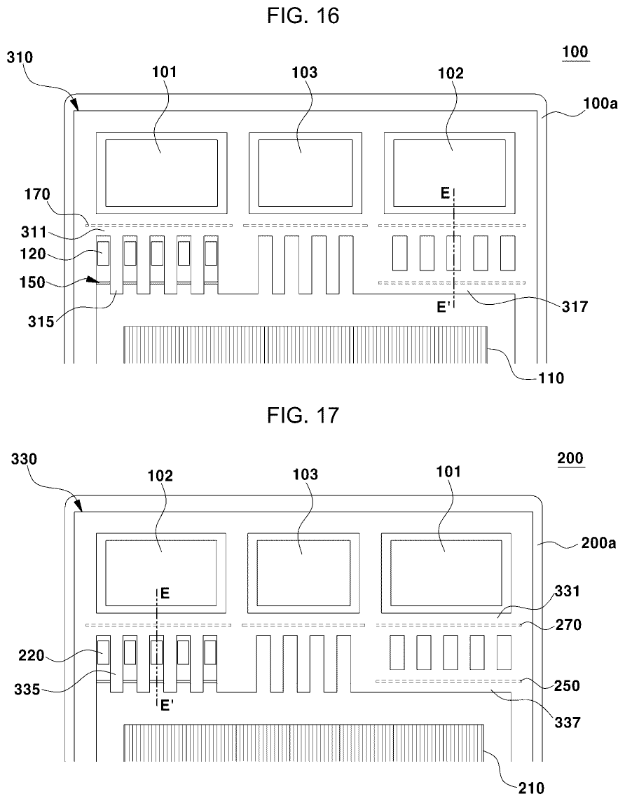

FIG. 15 is a cross-sectional view of a separator assembly to which the forming portion of FIG. 13 is applied.

Referring to FIG. 15, a part of the second forming portion 251 provided on the cathode separator 200 may be exposed through the third main gasket 351. The second forming portion 251 externally exposed of the third main gasket 351 may come into direct contact with a first forming portion 150. Accordingly, the first forming portion 150 coming into contact with the second forming portion 251 may be a forming portion provided on an anode separator 100 belonging to an adjacent unit cell. The anode separator 100 and the cathode separator 200 disposed so that the reaction surfaces thereof face each other may form one unit cell. However, the space where the first forming portion 150 and the second forming portion 251 come into contact with each other is the space between the cooling surfaces 100b, 200b where reaction gases do not flow, so a short circuit problem due to contact between the separators may not occur.

A part of the third forming portion 271 provided on the cathode separator 200 may be exposed through the second main gasket 331. The third forming portion 271 externally exposed of the second main gasket 331 may come into direct contact with a sub-gasket 500 or a first main gasket 311 on an anode separator 100, which is another separator disposed adjacent to the cathode separator 200. The third forming portion 271 may come into contact with the first main gasket 311 disposed on an anode separator 100 belonging to another unit cell, rather than on the anode separator 100 forming the unit cell.

According to an exemplary embodiment of the present disclosure, as the second forming portion 251 comes into direct contact with the first forming portion 150 and the third forming portion 271 comes into direct contact with the sub-gasket 500 or the first main gasket 311 of the adjacent anode separator 100, a phenomenon of surface pressure dropping in the area where the supports provided on each of the reaction surface 200a and the cooling surface 200b of the cathode separator 200 are not disposed may be alleviated. Also, the second forming portion 251 and the third forming portion 271 is configured as spacers to prevent the gasket made of a rubber material from being excessively compressed.

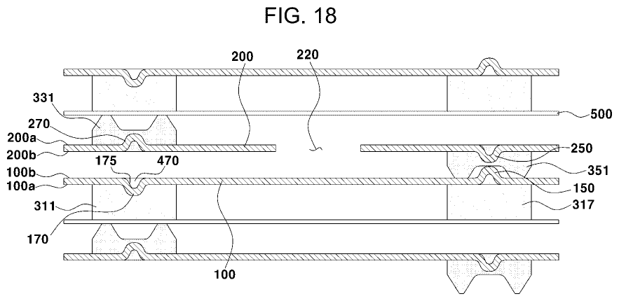

FIG. 16 shows a modification of the first gasket disposed on the anode separator according to an exemplary embodiment of the present disclosure, FIG. 17 shows a modification of the second gasket disposed on the cathode separator according to an exemplary embodiment of the present disclosure, and FIG. 18 is a cross-sectional view along line E-E′ of FIG. 16 and FIG. 17. For the sake of brevity, a redundant description of FIGS. 2 and 4 is omitted.

Referring to FIGS. 16 to 18, the anode separator 100 may be provided with a first forming portion 150 and an additional forming portion 170. The additional forming portion 170 may be a fourth forming portion 170. The fourth forming portion 170 may protrude from the cooling surface 100b of the anode separator 100 toward the reaction surface 100a thereof. The fourth forming portion 170 may be a portion in which a part of the anode separator 100 is curved. A fourth concave portion 175, which is a recessed portion, may be formed on the rear surface of the fourth forming portion 170 exposed through the cooling surface 100b of the anode separator 100. A fourth sealing portion 470 may be provided in the fourth concave portion 175.

The fourth forming portion 170 may be provided at a position overlapping the first main gasket 311. The first main gasket 311 may be formed on the fourth forming portion 170, and the fourth forming portion 170 is configured as a frame of the first main gasket 311.

A plurality of fourth forming portions 170 may be provided between the manifolds 101, 102, 103 and the reaction area 110 of the anode separator 100. For example, six fourth forming portions 170 may be provided. The fourth forming portions 170 may be located adjacent to the manifolds 101, 102, 103 compared to the first forming portions 150. Accordingly, the manifolds 101, 102, 103, the fourth forming portions 170, and the first forming portions 150 may be sequentially located in a direction from one side of the anode separator 100 to the remaining side thereof. The fourth forming portions 170 may be located adjacent to the manifolds 101, 102, 103 based on the position where the first flow holes 120 are disposed. The first fluid hole 120 may be disposed between the first forming portion 150 and the fourth forming portion 170. The length of each of the fourth forming portions 170 based on the first direction may be greater than the length of each of some manifolds 101, 102, 103 provided at corresponding positions. For example, the length of the fourth forming portion 170 provided adjacent to the first inlet manifold 101 may be greater than the length of the first inlet manifold 101 based on the first direction. The length of each of the first forming portions 150 may be the same as the length of each of the fourth forming portions 170 provided at corresponding positions based on the manifolds 101, 102, 103. For example, the length of the fourth forming portion 170 provided adjacent to the first inlet manifold 101 may be the same as the length of the first forming portion 150 provided adjacent to the first inlet manifold 101. However, the length of the fourth forming portion 170 provided adjacent to the first inlet manifold 101 may be greater than the length of the fourth forming portion 170 provided adjacent to the coolant manifold 103. Also, the length of the fourth forming portion 170 provided adjacent to the coolant manifold 103 may be less than the length of the first forming portion 150. The fourth forming portions 170 provided in the first direction may be spaced apart from each other. Although FIG. 16 shows only one side of the anode separator 100, the fourth forming portions 170 may be provided at positions adjacent to manifolds formed on the remaining side of the anode separator 100.

The first flow holes 120 may be formed to correspond to the first inlet manifold 101. A first connecting portion 317 may be provided at the end portion of each of the first supports 315 extending to the reaction area 110 from the second outlet manifold 102 where flow holes through which reaction gases flow are not formed. One end portion of each of the first supports 315 may be connected to the first main gasket 311, and the remaining end portion of each of the first supports 315 may be connected to the first connecting portion 317. The first connecting portion 317 may be provided on the first forming portion 150. In the area where flow holes through which reaction gases flow are not formed, the first connecting portion 317 which is connected to all end portions of the first supports 315 may be provided to increase the surface pressure, reinforcing the stacked structure of the separators.

The third flow holes 220 may be formed to correspond to the second outlet manifold 102. A second connecting portion 337 may be provided at the end portion of each of the second supports 335 extending to the reaction area 210 from the first inlet manifold 101 where flow holes through which reaction gases flow are not formed. One end portion of each of the second supports 335 may be connected to the second main gasket 331, and the remaining end portion of each of the second supports 335 may be connected to the second connecting portion 337. The second connecting portion 337 may be provided on the second forming portion 250. In the area where flow holes through which reaction gases flow are not formed, the second connecting portion 337 which is connected to all end portions of the second supports 335 may be provided to increase the surface pressure, reinforcing the stacked structure of the separators.

In a state where the anode separator 100 and the cathode separator 200 are stacked, the first connecting portion 317 may be disposed to overlap the end portions of the second supports 335 disposed between the third flow holes 220. The second connecting portion 337 may be disposed to overlap the end portions of the first supports 315 disposed between the first flow holes 120. Based on one unit cell, the third forming portion 270 and the fourth forming portion 170 may protrude in directions facing each other, and the first forming portion 150 and the second forming portion 170 may protrude in directions opposite to each other. However, the first forming portion 150 and the second forming portion 170 provided on the cooling surface 100b of the anode separator 100 and the cooling surface 200b of the cathode separator 200 facing each other may protrude in a direction facing each other.

According to an exemplary embodiment of the present disclosure, the first forming portion 150 and the second forming portion 250 located adjacent to the central area of each of the separators 100, 200 are in contact with each other, and the first connecting portion 317 and the second connecting portion 337 are provided to prevent the surface pressure from being lowered by the first supports 315 and the second supports 335, achieving reinforcement of the stacked structure of the separators 100, 200.

As is apparent from the foregoing, according to an exemplary embodiment of the present disclosure, warping of a fuel cell separator may be reduced by forming portions including a curved shape. Although there is a problem in that the surface pressure of a unit cell becomes low in an area where gasket supports are not provided among areas adjacent to manifolds through which reaction gases or coolant flow in and out, the effect of enhancing surface pressure of the unit cell may be generated by the forming portions.

According to an exemplary embodiment of the present disclosure, the direction in which reaction gases flow and the direction in which the forming portions protrude do not coincide with each other, so that the surface pressure between separators may be increased without the flow of the reaction gases being obstructed by the forming portions.

According to an exemplary embodiment of the present disclosure, rigidity of the forming portions and the separators including the same may be improved by filling the rear surface of each of the forming portions protruding unidirectionally with a sealing material.

According to an exemplary embodiment of the present disclosure, a first forming portion and a second forming portion located adjacent to the central region of each of the separators are in contact with each other, and a first connecting portion and a second connecting portion are provided to prevent surface pressure from being lowered by the first and second supports, achieving reinforcement of the stacked structure of the separators.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A fuel cell separator, comprising:
at least one separator provided with a plurality of manifolds and a reaction area and including a forming portion protruding in a direction from a reaction surface of the at least one separator toward a cooling surface of the at least one separator,
wherein the forming portion extends along a first direction in which the plurality of manifolds disposed on one side of the at least one separator is provided, and
wherein the forming portion is provided at a position where a gasket disposed on the reaction surface is discontinuously disposed in the first direction.

2. The fuel cell separator of claim 1,
wherein the forming portion includes a concave portion which is a region where the reaction surface is recessed, and
wherein a sealing portion is disposed in the concave portion.

3. The fuel cell separator of claim 1, further including a plurality of supports,
wherein the gasket includes a main gasket disposed along a perimeter of the plurality of manifolds and a support extending from the main gasket toward the reaction area, and
wherein the forming portion is provided at a position where the plurality of supports is provided in the first direction.

4. The fuel cell separator of claim 3,
wherein the at least one separator further includes a modified forming portion protruding toward the support, and
wherein the forming portion and the modified forming portion are alternately disposed in the first direction.

5. The fuel cell separator of claim 4,
wherein the forming portion is disposed between two adjacent supports among the plurality of supports, and
wherein the modified forming portion extends as wide as the support based on the first direction.

6. The fuel cell separator of claim 3,
wherein the at least one separator includes an additional forming portion provided at a position corresponding to the main gasket disposed between the reaction area and each of the manifolds, and
wherein the additional forming portion protrudes from the cooling surface toward the reaction surface.

7. The fuel cell separator of claim 1,
wherein the forming portion is in plural,
wherein the plurality of forming portions are provided between the reaction area and each of manifolds through which reaction gases flow among the plurality of manifolds, and
wherein a length of each of the forming portions based on the first direction is greater than a length of each of the manifolds provided at corresponding positions thereof.

8. A fuel cell separator assembly, comprising:
a first separator including a reaction surface, a cooling surface and a first forming portion protruding from the reaction surface toward the cooling surface;
a second separator including a reaction surface, a cooling surface and a second forming portion protruding from the reaction surface of the second separator toward the cooling surface of the second separator;
a first gasket disposed on the reaction surface of the first separator;
a second gasket disposed on the reaction surface of the second separator; and
a third gasket disposed on the cooling surface of the second separator,
wherein the first forming portion and the second forming portion extend along a first direction in which a plurality of manifolds disposed on one side of the first separator or the second separator is provided.

9. The fuel cell separator assembly of claim 8,
wherein the first forming portion is provided at a position where the first gasket is discontinuously disposed in the first direction, and
wherein the second forming portion is provided at a position where the second gasket is discontinuously disposed in the first direction.

10. The fuel cell separator assembly of claim 8, wherein the second separator includes a third forming portion protruding from the cooling surface of the second separator toward the reaction surface of the second separator.

11. The fuel cell separator assembly of claim 10, wherein the third forming portion is disposed adjacent to the plurality of manifolds compared to the second forming portion.

12. The fuel cell separator assembly of claim 8,
wherein the first gasket includes a first main gasket disposed along a perimeter of the plurality of manifolds and a first support extending from the first main gasket toward a reaction area of the first separator,
wherein the second gasket includes a second main gasket disposed along a perimeter of the plurality of manifolds and a second support extending from the second main gasket toward a reaction area of the second separator,
wherein the first forming portion is provided at a position where a plurality of first supports is provided in the first direction, and
wherein the second forming portion is provided at a position where a plurality of second supports is provided in the first direction.

13. The fuel cell separator assembly of claim 12, wherein the second separator further includes a third forming portion protruding from the cooling surface of the second separator toward the reaction surface of the second separator, and the third forming portion is provided at a position overlapping the second main gasket.

14. The fuel cell separator assembly of claim 13, wherein the third gasket is disposed on the second forming portion, and the second gasket is disposed on the third forming portion.

15. The fuel cell separator assembly of claim 14,
wherein a part of the second forming portion is exposed through the third gasket,
wherein the first separator and the second separator are alternately stacked, and
wherein the part of the second forming portion exposed through the third gasket is in contact with the first forming portion protruding toward the cooling surface of the second separator.

16. The fuel cell separator assembly of claim 14,
wherein a part of the third forming portion is exposed through the second gasket, and
wherein the exposed part of the third forming portion is in contact with a sub-gasket disposed between the first separator and the second separator or the first gasket disposed on the first separator.

17. The fuel cell separator assembly of claim 12,
wherein the first separator further includes a fourth forming portion protruding from the cooling surface of the first separator toward the reaction surface of the first separator, and
wherein the fourth forming portion is provided at a position overlapping the first main gasket.

18. The fuel cell separator assembly of claim 17,
wherein the first separator further includes a flow hole through which a reaction gas flows, and
wherein the flow hole is provided between the first forming portion and the fourth forming portion.

19. The fuel cell separator assembly of claim 8,
wherein the first forming portion includes a first concave portion which is a region where the reaction surface of the first separator is recessed,
wherein the second forming portion includes a second concave portion which is a region where the reaction surface of the second separator is recessed, and
wherein the first concave portion and the second concave portion are filled with an elastic material.
